(19) United States
(12) Patent Application Publication
(10) Pub. No.: US 2007/0126359 A1
(43) Pub. Date: Jun. 7, 2007

(54) PLASMA DISPLAY PANEL HAVING MOISTURE-PROOF STRUCTURE FOR PROTECTING ELECTRODES AND METHOD OF MANUFACTURING THE SAME

(75) Inventor: Woong Kee Min, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/555,613

(22) Filed: Nov. 1, 2006

(30) Foreign Application Priority Data
Nov. 1, 2005 (KR) 10-2005-0103716

(51) Int. Cl. H01J 17/49

(52) U.S. Cl. 313/583

(57) ABSTRACT

Disclosed herein is a Plasma Display Panel (PDP) that adopts a moisture-proof structure to protect the adhesive portions of connection pads for driving electrodes. The PDP includes a front panel, a rear panel, a group of electrodes, and a plurality of conductive pads. The group of electrodes are each configured to have a predetermined first line width and are formed on at least one of the front panel and the rear panel. The conductive pads are configured to allow the group of electrodes to be electrically connected with the corresponding electrodes, and are each configured to have a second line width greater than the first line width. The structure of the PDP can effectively protect an overall panel pad from external moisture.

This non-provisional application claims priority under 35 U.S.C. § 119 (a) on patent application Ser. No. 10-2005-0103716 filed in Korea on Nov. 1, 2005 the entire contents of which are hereby incorporated by reference.

### BACKGROUND

1. Field

This application related generally to a plasma display panel that adopts a moisture-proof structure to protect the adhesive portions of connection pads for driving electrodes.

2. Description of Related Art

FIG. 1 is an exploded perspective view schematically showing the structure of a conventional Alternating Current (AC) three-electrode surface discharge Plasma Display Panel (PDP). Referring to FIG. 1, the PDP includes a front panel 10 configured to display information and a rear panel 20 disposed on a plane that is oriented parallel to a plane upon which the front panel 10 is disposed.

The front panel 10 includes a plurality of pairs of display electrodes X and Y arranged with relative orientations parallel to each other on a glass substrate 11, and the rear panel 20 includes a plurality of address electrodes A arranged with an orientation perpendicular to the display electrodes X and Y on a glass substrate 21. In the front panel 10 and the rear panel 20, the display electrodes X, Y and the address electrodes A are respective arranged in rows and columns.

Generally, the display electrodes X, Y are composed of conductive films 13 that are transparent electrodes, such as indium tin oxide (ITO). In order to compensate for the high resistance characteristic of transparent conductive films 13, bus electrodes 14, which are made conductive metal material, are arranged along the edges of the transparent conductive films 13. A dielectric layer 15, which is made of a low-melting point glass material having a thickness of above 30 μm, is applied to the display electrodes X and Y, and a protecting layer 16, such as a magnesium oxide layer, is deposited on the surface of the dielectric layer.

The address electrodes A are made of conductive metal material, and are generally coated with a dielectric layer (not shown) to the thickness of about 10 μm. Barrier ribs 24 having a height of about 150 μm are arranged with an orientation parallel to the address electrodes A on the dielectric layer. Discharge spaces are defined for respective sub-pixels by these barrier ribs 24. Red, green and blue phosphor layers 25 for displaying colors are disposed in the respective discharge spaces within the barrier ribs 24, a pixel including a set of red, green, phosphor layers. The discharge spaces between the front panel 10 and the rear panel 20 are charged with a discharge gas for plasma discharge, and one pixel above the phosphor layers 25 includes three sub-pixels arranged parallel to each other in a row direction. The structure of each sub-pixel is generally referred to as a cell.

The pairs of display electrodes X and Y and the address electrodes A are driven by an X driver, a Y driver and a Z driver, respectively.

FIG. 2 is a plan view showing the conventional PDP. Referring to FIG. 2, the PDP is provided with a pixel area PA, which is formed of the sub-pixels described in conjunction with FIG. 1, in a sealed inner space formed through the bonding of the front panel 10 and the rear panel 20, and a pad area (not identified by reference numeral in FIG. 2) is formed in the peripheral region of the front and rear panels 10 and 20 of the PDP. In the pad area, a plurality of metal electrode pads P_{X}, P_{Y} and P_{A} are formed for connecting a plurality of electrode groups, that is, a scan electrode group, a sustain electrode group and an address electrode group, which are formed in the pixel area PA, to respective driver circuits. The pads P_{X}, P_{Y} and P_{A} are generally made of a low-resistance metal material containing Ag.

In the PDP having a three-electrode surface discharge structure, described above in conjunction with FIG. 1, the scan electrode pads F_{Y}, which are connected with the respective scan electrodes Y that are present in the pixel area PA, and the sustain electrode pads P_{X}, which are connected with the respective sustain electrodes X that are present in the pixel area PA, are respectively formed on the left and right ends of the front panel 10 corresponding to the number of sub-pixels. Furthermore, the address electrode pads P_{A} are formed on the lower and/or upper end of the rear panel 20. Although, for ease of description, the electrode pads are illustrated as being separately formed at the ends of corresponding electrodes in the present specification, it should be noted that the electrode pads may be formed as parts of corresponding electrodes and that the locations for forming the electrodes pads may also be changed in various ways according to the arrangement of the electrodes, which are formed on the front and rear panels 10 and 20 of the PDP, and according to the driving method thereof.

Flexible Printed Circuits (FPCs) are attached to the pad area of the PDP. The FPC is used to connect the electrode groups of the pixel area PA to the driving circuits located outside the PDP.

FIG. 3 is a diagram showing a section of the pad area of FIG. 2 after the FPC is installed. In particular, FIG. 3 shows a section taken along a line A-A′ (FIG. 2) of an address electrode pad area in the pad area.

As shown in FIG. 3, the FPC 40 includes a plurality of conductive pads 44 formed on a flexible resin film 42. Each of the conductive pads 44 is formed of a single-layered or multi-layered film that is made of at least one of Cu, Sn, Ni and Au materials. The FPC 40 may be a Tape Carrier Package (TCP) or Chip On FPC (COF) on which Driving Integrated Circuits (ICs) (not shown) are mounted for supplying driving signals to the electrode pads P_{A}, P_{X} or P_{Y} through the conductive pads 44.

The conductive pads 44 of FPC 40 come into electrical contact with respective address electrode pads P_{A}. Such electrical contact is generally made with an Anisotropic Conduction Film (ACF) 46 interposed therebetween. The ACF 46 is made of adhesive material in which metal balls (not shown) are distributed, and the conductive pads 44 and the address electrode pads P_{A} are electrically connected through the balls (not shown) that are hardened and distributed by heating and pressing.

FIG. 4 is a plan view showing a portion of the pad area in which the address electrode pads P_{A} and the conductive pads 44 are adhered to the FPC 40.

As shown in FIG. 4, the FPC 40 is aligned so that portions of the address electrode pads P_{A} of the pad area are covered therewith, and the remaining portions of the address electrode pads P_{A} are exposed outside the panel. In this case, when the conductive pads 44 have the same line width as the address electrode pads P_{A}, exposed areas EAs, in which the portions of the address electrode pads P_{A} are not covered with the conductive pads 44, are created due to misalignment.

Accordingly, at the exposed areas EA, electromigration might cause an electric short to be generated between the remaining exposed portions of the address electrode pads P_{A}, which are covered with the FPC 40, and the conductive pads 44. Furthermore, when the electrode pads P_{A} are made of a composition containing Ag, the above described phenomenon is intensified.

First, when a potential difference exists between a pair of neighboring address electrode pads P_{A} and moisture is interposed therebetween, an aqueous colloid solution is created because the ionization of Ag occurs on an anode pad side. Thereafter, reactions through which Ag is oxidized, deoxidized, diffused and hydrolyzed in the colloidal solution and is then extracted after the movement thereof to a cathode, occur sequentially. These reactions can be represented by the following chemical formulas 1 to 5.

The ionization of an Ag anode due to moisture
Ag→Ag⁺+e⁻
H₂O→H++OH⁻ (1)

The generation of AgOH colloid on an anode side
Ag⁺+OH→AgOH (2)

Diffusion in the colloid after the generation of Ah₂O
2AgOH→AgO₂+H₂O (3)

Hydrolysis
Ag₂O+H₂O→2AgOH→2Ag⁺+2OH⁻ (4)

The extraction of Ag on the cathode
Ag⁺+e⁻→Ag

Ag extracted on the cathode through the above-described reactions grows gradually and, as a result, causes the neighboring pads to be short-circuited.

Currently, as the line width and distance between address electrodes A are reduced to satisfy the trend toward a large-sized and high-definition panel, the probability of the occurrence of variation due to the tolerance in the manufacturing process increases, therefore the above-described problem may be more serious.

To prevent the problem, the conventional technology, as shown in FIG. 3, uses a method of attaching the electrode pads P_{A} to the FPC 40 and forming a moisture-proof coating layer PL on the resultant product. However, even when using this method, defects due to an electric short between the electrode pads P_{A} continue to be generated in the PDP.

### BRIEF DESCRIPTION OF THE DRAWINGS

Features of the subject technology will be more clearly understood from the following detailed description taken in conjunction with the accompanying drawings, in which:

FIG. 1 is an exploded perspective view schematically showing the structure of a conventional AC three-electrode surface discharge PDP;

FIG. 2 is a plan view showing the conventional PDP;

FIG. 3 is a diagram showing a section of the panel pad area of FIG. 2 after the FPC is installed;

FIG. 4 is a plan view showing a portion of a panel pad area in which address electrode pads and conductive pads are adhered to the FPC;

FIG. 5 is a plan view showing the structure of a PDP;

FIG. 6A is a plan view showing an example in which the conductive pads of an FPC are aligned in the panel pad area, which is described in conjunction with FIG. 5;

FIG. 6B is a sectional view showing a section taken along a line B-B′ of a contact portion between the conductive pad and the driving electrode of FIG. 6A;

FIG. 7A is a plan view showing another example in which the conductive pads of the FPC are aligned in the panel pad area, which is described in conjunction with FIG. 5;

FIG. 7B is a sectional view showing a section of a contact portion between the conductive pad and driving electrode pad of FIG. 7A; and

FIG. 7C is a sectional view showing a section taken along a line D-D′ of a contact portion between the conductive pad and the driving electrode pad of FIG. 7A.

### DETAILED DESCRIPTION

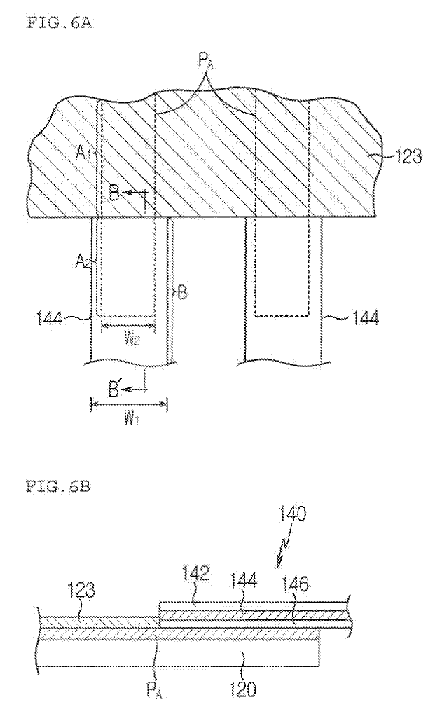

Referring to FIG. 5, a PDP may be configured with a front panel 110 and a rear panel 120. A pixel area PA is formed in a sealed inner space between the front panel 110 and the rear panel 120, which is defined by the bonding of the front panel 110 and the rear panel 120. Although not shown, the pixel area PA includes a plurality of sub-pixels. A plurality of electrode groups and barrier ribs, which are formed on the front panel 110 and/or the rear panel 120, divides a discharge space between the front and rear panels 110 and 120 into a plurality of sub-pixels, thus defining the pixel area PA.

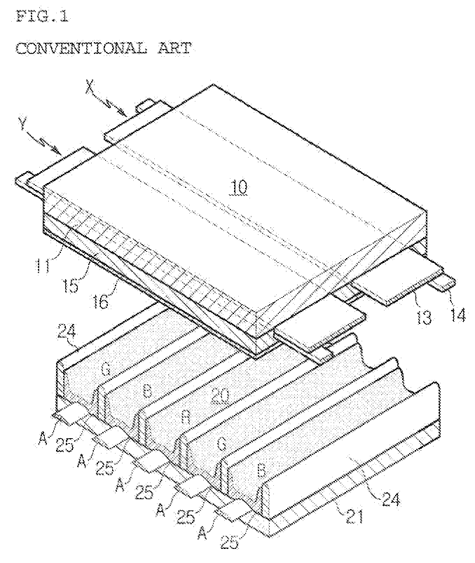

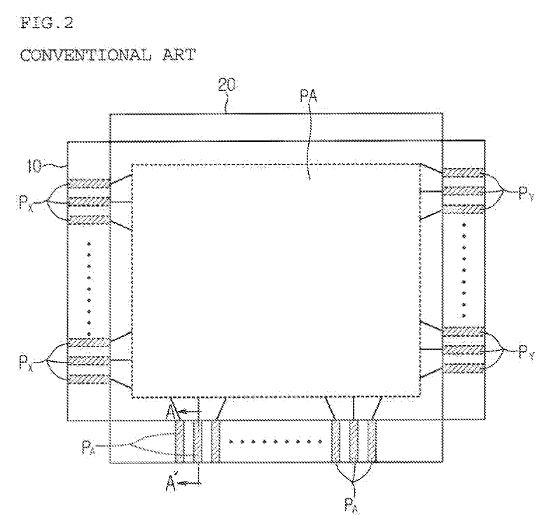

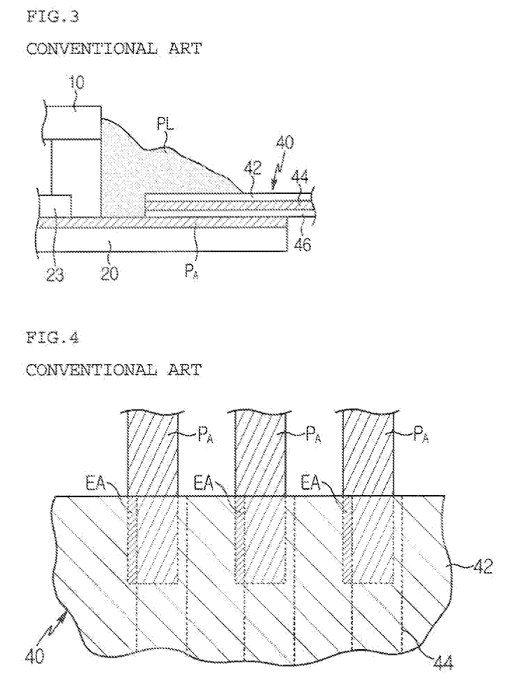

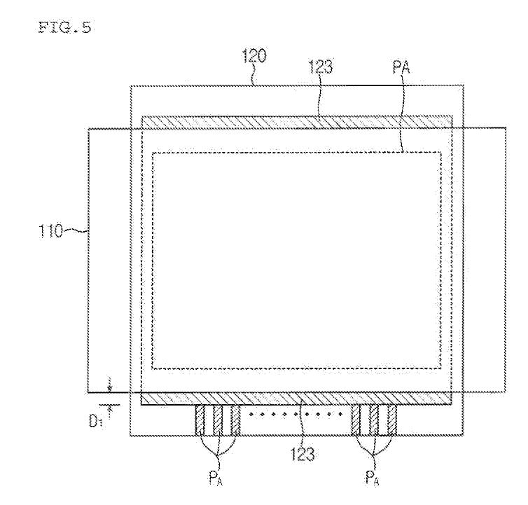

The electrode groups may include a sustain electrode group, a scan electrode group and an address electrode group, and may be appropriately disposed on the front panel 110 and/or the rear panel 120 according to the structure or driving method of the panel. The present implementation involves an application of concepts set forth herein to a PDP having a three-electrode surface discharge structure, which is described in conjunction with FIG. 1. Accordingly, a detailed description of the arrangement of driving electrodes is not reproduced here.

The groups of electrodesPA are connected to external driving circuits through a plurality of electrode pads P_{A} exposed outside the inner space between the front panel 110 and the rear panel 120. In FIG. 5, only the address electrode pads P_{A} among the plurality of electrode pads, which are formed on the rear panel 120, are shown, and sustain electrodes and scan electrodes, which are formed on the front panel 120, are omitted. However, since these concepts may be applied to electrode pads other than the address electrode pads, the address electrode pads P_{A} are referred to as driving electrode pads, which also or alternatively may include both the sustain electrode pads and the scan electrode pads, in the following description.

The panel structure includes a moisture-proof dielectric layer 123 that exists outside the sealed inner space defined by the front panel 110 and the rear panel 120. The moisture-proof dielectric layer 123 covers a portion of the driving electrode pads P_{A} exposed outside the sealed inner space of the panel. The moisture-proof dielectric layer 123 may be a white back dielectric layer, which enables the moisture-proof dielectric layer 123 to be provided without requiring a separate additional process if the white back dielectric layer is formed after the address electrodes are formed.

The extended length D1 of the moisture-proof dielectric layer 123 must be appropriately set such that portions of the driving electrode pads P_{A} having the minimum length can be exposed to allow the driving electrode pads P_{A} and the conductive pads 144 of an FPC 140 to realize excellent, electrical connection therebetween.

Limitations may not be imposed upon the thickness of the moisture-proof dielectric layer 123. Alternatively, the moisture-proof dielectric layer 123 may have a thickness of about 1-30 μm.

Meanwhile, although FIG. 5 shows the moisture-proof dielectric layer 123 formed on the address electrode pads PA, the moisture-proof dielectric layer 123 may also or alternatively be formed on the scan electrode pads (not shown) and/or sustain electrode pads (not shown) of the front panel 110.

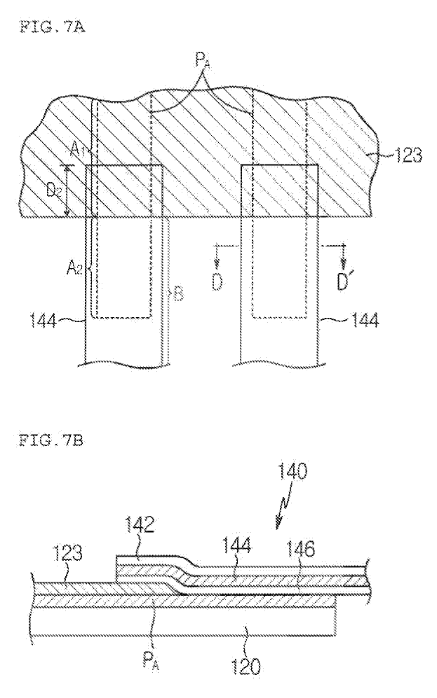

FIG. 6A is a plan view showing an example in which the conductive pads 144 of the FPC 140 are aligned in the panel pad area, which is described in conjunction with FIG. 5. For ease of illustration, only the FPC conductive pads 144 are shown.

Referring to FIG. 6A, the conductive pads 144 of the FPC are adhered to one end of the moisture-proof dielectric layer 123. In the implementation shown, the conductive pads 144 of the FPC 140 are aligned to the respective exposed ends of the driving electrode pads P_{A} so that the FPC 140 and the moisture-proof dielectric layer 123 do not overlap each other. The line width of the conductive pads 144 of the FPC 140 is greater than that of the driving electrode pads P_{A}. For instance, the line width W1 of the conductive pads 144 may be greater than the line width W2 of the driving electrode pads P_{A} by about 10 μm or more, or 20 μm or more, in at least one direction. As described above, the conductive pads 144 having a line width greater than that line width W2 of the driving electrode pads are used, enabling the driving electrode pads P_{A} to be sufficiently covered by the conductive pads 144 of the FPC even when the conductive pads 144 of the FPC 140 and the driving electrode pads P_{A} are misaligned.

As shown in FIG. 6B, the driving electrode pads P_{A} are formed in the pad area of the rear panel 120, and portions of the driving electrode pads P_{A} are covered with moisture-proof dielectric layer 123.

The FPC 140 is attached to exposed portions of the driving electrode pads P_{A}, which are located beside the end of the moisture-proof dielectric layer 123. The FPC 140 includes the plurality of conductive pads 144 that are formed on respective flexible resin films 142. Each of the conductive pads 144 may be formed of a single-layered or multilayered film containing at least one of metal material made of Cu, Sn, Ni and/or Au, but which does not contain Ag. The FPC 140 may be a TCP or COF upon which driving ICs (not shown) are mounted for supplying driving signals to the driving electrode pads P_{A} through the conductive pads 144. The FPC 140 and the driving electrode pads P_{A}, as described above, are electrically connected with an intermediate layer, such as an ACF 146, interposed therebetween.

With reference to FIG. 6A again, in the pad structure, a mechanism for preventing electromigration caused by the driving electrode pads P_{A} is described below.

First, portion A1 of a driving electrode pad P_{A} protruding from the inner space of the panel to the outside is protected by the moisture-proof dielectric layer 123. The moisture-proof dielectric layer 123 may be baked along with the baking of the dielectric layer formed on the address electrodes of the panel, and has a very compact and fine structure, which assists layer 123 insufficiently interrupting the penetration of moisture.

Thereafter, Portion A2 of the portions of the protruded driving electrode pad P_{A} is protected by the conductive pad 144 of the FPC, which is set to have a line width greater than that of the driving electrode pad P_{A}. The electromigration caused by the driving electrode pad P_{A} occurs under a potential difference between neighboring driving electrode pads P_{A}. Such potential differences are prevented or reduced by covering the driving electrode pad P_{A} completely with the conductive pads 144 of the FPC 140, placing the conductive pads 144 into electrical contact with the driving electrode pad P_{A} to place the driving electrode pad P_{A} into an equipotential state relative to the conductive pad 144. Accordingly, neighboring the driving electrode pads P_{A} do not undergo and potential difference, so that electromigration does not occur even when the penetration of moisture occurs.

Finally, although a potential difference may occur between portions B of neighboring conductive pads 144, the probability of the occurrence of electromigration is remarkably low in contrast to Ag or an Ag alloy because the conductive pads 144 are made of, for example, any of metal materials, such as Cu, Sn, Ni and Au, other than Ag, or an alloy containing one or more metal materials, or an alloy composed of a combination of the metal materials.

As described above, the moisture-proof dielectric layer 123 is formed, or the line width of the conductive pads 144 is adjusted depending on the exposed portions of the pads, so that electromigration that might otherwise be caused by the portions of each pad protruding outside the panel can be restrained.

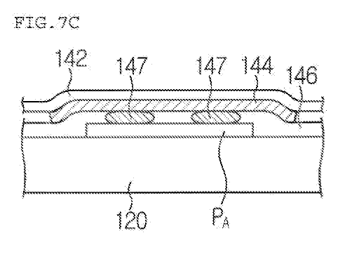

FIG. 7A is a plan view showing another example in which the conductive pads 144 of the FPC 140 are aligned in the panel pad area, which is described in conjunction with FIG. 5.

Referring to FIG. 7A, the conductive pads 144 of the FPC 140 are adhered to the end of the moisture-proof dielectric layer 123. In this implementation, the FPC 140 is aligned and adhered so as to slightly overlap the moisture-proof dielectric layer 123, unlike FIG. 6A. The reason why the FPC is to be disposed so as to slightly overlap the moisture-proof dielectric layer is to prevent moisture from penetrating into a boundary surface between the conductive pads 144 and the moisture-proof dielectric layer 123.

The overlapping length of the conductive pads 144 of the FPC and the moisture-proof dielectric layer 123 can be greater then 0.5 mm. Furthermore, the overlapping range of the conductive pads 144 of the FPC 140 and the moisture-proof dielectric layer 123 may be appropriately designed in consideration of the loss of the drive voltage due to a parasite capacitance that occurs between the conductive pads 144 of the FPC 140 and the driving electrode pads P_{A} between which the moisture-proof dielectric layer 123 is interposed.

FIG. 7B is a sectional view showing a section of a contact portion between a conductive pad 144 and driving electrode pad P_{A} of FIG. 7A. As shown in FIG. 7B, the flexible resin film 142 and conductive pads 144 of the FPC 140 are formed such that a portion of the moisture-proof dielectric layer 123 formed on the driving electrode pad P_{A} is covered therewith. The ACP 146 described above is interposed between the conductive pads 144 of the FPC and the driving electrodes pad P_{A}.

FIG. 7C is a sectional view showing a section taken along a line D-D′ of a contact portion of the conductive pad 144 and the driving electrode pad P_{A} of FIG. 7A.

Referring to FIG. 7C, the driving electrode pad P_{A} formed on the rear panel 120 is electrically connected with the conductive pads 144, and the ACF 146 is interposed therebetween. As shown in FIG. 7C, an electrical connection between the two layers is made through metal balls distributed in the ACF 146. Furthermore, it can be seen that the conductive pad 142 of the FPC 140 has a line width greater than that of the driving electrode pad P_{A} and thus surrounds the driving electrode pad P_{A}.

A method of implementing a PDP structure is described below, and method of manufacturing a PDP also is contemplated.

First, when a front panel and a rear panel, each of which is formed of a transparent substrate, are provided, a pixel area, which is formed of a plurality of sub-pixels, and a sealed space, which surrounds the pixel area, are defined in the front panel and the rear panel. Thereafter, an electrode group, which is used to drive the sub-pixels, is formed on the front panel and/or the rear panel, and a plurality of driving electrode pads, which is used to supply power to the respective ends of electrodes constituting the electrode group, is formed outside the sealed space. Thereafter, a dielectric layer is formed such that the electrode group and the portions of the plurality of driving electrode pads are covered with the dielectric layer. In this case, the dielectric layer is formed such that the portions of the pads exposed outside the sealed space are covered with the dielectric layer. Thereafter, barrier ribs, which enable division into the plurality of sub-pixels, and phosphor layers are formed on the front panel or the rear panel, and the front panel and the rear panel are sealed by being bonded together. FPC pads are attached to respective driving electrode pads such that a portion of the dielectric layer is interposed between the plurality of driving electrode pads, which are exposed outside the sealed space, and the FPC pads in the pad area of the pane manufactured as described above.

As described above, an effective panel structure for protecting the respective electrode pads of the exposed pad areas from external moisture can be achieved through the control of the extended length of the moisture-proof dielectric layer 123 and the line width of the conductive pads 144 of the FPC 140 with the division of the panel pad area, even if the size and resolution of the panel increase.

In one implementation of the pane structure, the moisture-proof dielectric layer can be formed concurrent with (and integrated as part of the process of) the forming of the internal electrode dielectric layer of the panel, so that a separately added process is not required in order to form the moisture-proof dielectric layer. Furthermore, the moisture-proof dielectric layer formed as described above is just as compact as the electrode dielectric layer, so that it is suitable for protecting the electrode pads from moisture.

Although various features have been disclosed for illustrative purposes, modifications, additions, and substitutions are possible.

What is claimed is:

1. A plasma display panel, comprising:
a front panel and a rear panel defining a space therebetween;
electrodes configured with a first line width and located on at least one of the front panel and the rear panel, at least a portion of the electrodes being located within the space defined between the front panel and the rear panel; and
conductive pads positioned on a plane that is parallel to the panel on which the electrodes are located, the conductive pads being configured with a second line width that exceeds the first line width, at least one of the conductive pads being arranged to completely overlap a corresponding one of the electrodes and being electrically coupled with the corresponding electrode.

2. The plasma display panel as set forth in claim 1, wherein the at least one conductive pad is connected to a Flexible Printed Circuit to transmit an electrical signal to the corresponding electrode.

3. The plasma display panel as set forth in claim 1, wherein the PPC is a Tape Carrier Package (TCP) or a Chip On FPC (COF).

4. The plasma display panel as set forth in claim 1, wherein the at least one conductive pad and the corresponding electrode are electrically coupled through an Anisotropic Conduction Film (ACF).

5. The plasma display panel as set forth in claim 1, further comprising a dielectric layer positioned on the electrodes and extending over a location at which the conductive pads and the corresponding electrodes overlap each other.

6. The plasma display panel as set forth in claim 5, wherein the dielectric layer extends over the location at which the conductive pads and the corresponding electrodes overlap each other by a distance of 0.5 mm or more.

7. The plasma display panel as set forth in claim 1, wherein the at least one conductive pad has a line width that is wider than a line width of the corresponding electrode.

8. The plasma display panel as set forth in claim 7, wherein the at least one conductive pad has a line width that is wider than a line width of the corresponding electrode by 10 μm or more.

9. The plasma display panel as set forth in claim 7, wherein the at least one conductive pad has a line width that is wider than a line width of the corresponding electrode by 20 μm or more.

10. The plasma display panel as set forth in claim 1, wherein at least some of the electrodes are address electrodes.

11. The plasma display panel as set forth in claim 10, wherein at least some of the conductive pads are formed at an end of corresponding ones of the address electrodes, respectively.

12. The plasma display panel as set forth in claim 10, wherein the dielectric layer is a white back dielectric layer positioned on the address electrodes.

13. The plasma display panel as set forth in claim 1, wherein the corresponding electrode contains no Ag.

14. A plasma display panel, comprising:
a front panel and a rear panel defining a space therebetween;
electrodes configured with a first line width and located on at least one of the front panel and the rear panel, at least a portion of the electrodes being located within the space defined between the front panel and the rear panel; and
conductive pad means, positioned on a plane that is parallel to the panel on which the electrodes are located, for completely overlapping a corresponding one of the electrodes and being electrically coupled with the corresponding electrode.

15. A method of manufacturing a plasma display panel, comprising the steps of:
providing a front panel and a rear panel, each of which is formed of an at least partially transparent substrate;
defining a pixel area between the front panel and the rear panel;
forming a group of electrodes, which are used to drive the sub-pixels, on at least one of the front panel and the rear panel,
forming electrode pads) configured to supply power from outside the pixel area to corresponding electrodes within the group of electrodes;
forming a dielectric layer over a group of electrodes and portions of the electrode pads;
providing barrier ribs, which enable division of the pixel area into plural sub-pixels;
providing phosphor layers on the front panel or the rear panel;
creating a sealed space around the pixel area by bonding the front panel and the rear panel; and
positioning conductive pads to the electrode pads, the conductive pads being configured so that a portion of the dielectric layer is interposed between the conductive pads and the portion of the electrode pads positioned outside of the sealed space.

16. A plasma display panel, comprising:
front and rear panels with a sealed space defined therebetween;
a pixel area within the sealed space defined between the front and rear panels;
electrodes configured to drive pixels within the pixel area;
electrode pads positioned immediately adjacent one of the front and rear panels and at least partially outside of the pixel area, and electrically coupled to the electrodes to which the electrode pads supply power;
a dielectric layer positioned immediately adjacent a portion of the electrode pad that is immediately adjacent one of the front and rear panels, and extending from the pixel area along the surface of the electrode pad;
conductive pads corresponding to the electrode pads and covering the electrode pads as they extend beyond the dielectric layer, at least one of the conductive pads having a width that exceeds a width of a corresponding one of the electrode pads; and
a layer positioned between at least the one conductive pad and the corresponding electrode pad.

17. The plasma display panel of claim 16, wherein the layer positioned between the conductive pad and corresponding electrode pad is an Anisotropic Conductive Film (ACF) used to electrically couple the conductive pad and the corresponding electrode pad.

18. The plasma display panel of claim 16, wherein the electrode pad is an address electrode pad.

19. The plasma display panel of claim 16, wherein the dielectric layer and conductive layer at least partially overlap, separated by an end portion of the layer otherwise at least partially positioned between the conductive pad and the corresponding electrode pad.

20. The plasma display panel of claim 16, wherein the conductive pad does not include Ag.
